(19) United States
(12) Patent Application Publication
(10) Pub. No.: US 2013/0131980 A1
(43) Pub. Date: May 23, 2013

(54) RESOLVING GPS AMBIGUITY IN ELECTRONIC MAPS

(71) Applicant: Matthew L. Ginsberg, Eugene, OR (US)

(72) Inventor: Matthew L. Ginsberg, Eugene, OR (US)

(73) Assignee: On Time Systems, Inc., Eugene, OR (US)

(21) Appl. No.: 13/747,145

(22) Filed: Jan. 22, 2013

Related U.S. Application Data
(63) Continuation-in-part of application No. 11/851,953, filed on Sep. 7, 2007.
Application No. 11/851,953 is a continuation-in-part of application No. 13/542,938, filed on Jul. 6, 2012.
Application No. 13/542,938 is a continuation-in-part of application No. 13/352,013, filed on Jan. 17, 2012.
Application No. 13/352,013 is a continuation-in-part of application No. 12/886,100, filed on Sep. 20, 2010.
Application No. 12/886,100 is a continuation-in-part of application No. 12/821,349, filed on Jun. 23, 2010.
Application No. 12/821,349 is a continuation-in-part of application No. 12/639,770, filed on Dec. 16, 2009.
Application No. 12/639,770 is a continuation-in-part of application No. 13/425,707, filed on Mar. 21, 2012.
Application No. 13/425,707 is a continuation-in-part of application No. 11/851,953, filed on Sep. 7, 2007.
(60) Provisional application No. 61/233,123, filed on Aug. 11, 2009.

(51) Int. Cl. G01C 21/30

(52) U.S. Cl. CPC G01C 21/30
USPC 701/446

(57) ABSTRACT

An electronic map system obtains a vehicle's GPS fix from a GPS receiver and compares the fix with nearby map features such as road segments. Due to GPS inaccuracies, several such map features may correspond to a GPS fix. To determine which map feature should be shown as the location of the vehicle on the electronic map, the system infers a best fit among the map features that are close to the GPS fix by considering both distance and inferred characteristics of each map feature, such as prior GPS fixes and typical vehicle direction and speed on such feature. Some of these characteristics may be retrieved from a database and may be based on historical observations while others may be obtained in real time, for instance from on-board vehicle sensors.

### RELATED APPLICATIONS

This application is a continuation in part of co-pending U.S. patent application Ser. No. 11/851,953, filed Sep. 7, 2007, entitled “System and Method for Automated Updating of Map Information”, which is incorporated herein by reference and is a continuation in part of co-pending U.S. patent application Ser. No. 13/542,938, filed Jul. 6, 2012, entitled “Driver Safety Enhancement Using Intelligent Traffic Signals and GPS”, which is a continuation in part of co-pending U.S. patent application Ser. No. 13/352,013, filed Jan. 17, 2012, entitled “Driver Safety Enhancement Using Intelligent Traffic Signals and GPS”, which is a continuation in part of co-pending U.S. patent application Ser. No. 12/886,100, filed Sep. 20, 2010, entitled “Driver Safety System Using Machine Learning”, which is a continuation in part of U.S. patent application Ser. No. 12/821,349, filed Jun. 23, 2010, entitled “Traffic Routing Display System”, which is a continuation in part of U.S. patent application Ser. No. 12/639,770, filed Dec. 16, 2009, entitled “Traffic Routing Using Intelligent Traffic Signals, GPS And Mobile Data Devices” which claims priority pursuant to 35 U.S.C. §120 upon U.S. Provisional Patent Application No. 61/233,123 filed Aug. 11, 2009, all of which are incorporated herein by reference as if fully set forth herein. This application is also a continuation in part of co-pending U.S. patent application Ser. No. 13/425,707, filed Mar. 21, 2012, entitled “System and Method for Automated Updating of Map Information”, which is a continuation in part of co-pending U.S. patent application Ser. No. 11/851,953, filed Sep. 7, 2007, entitled “System and Method for Automated Updating of Map Information”, all of which are incorporated herein by reference as if fully set forth herein.

### BACKGROUND

1. FIELD OF ART

The present invention generally relates to updating and correcting perceived location of a user device on an electronic map display that can be used for vehicle navigation or similar purposes.

2. Description of the Related Art

Digital databases of road map information are essential components of a variety of useful applications, such as vehicle routing. The road map information databases used in vehicle routing systems describe the geographical location and intersections of the roads, or usage restrictions such as one-way restrictions or turn restrictions. The road map information databases also contain other metadata pertinent to vehicle routing, including traffic speeds over the various road segments, the names and address ranges of the roads, the road classification (residential, collector, arterial, highway/freeway) and the like. In conjunction with real-time location data, such as that provided by a satellite-based Global Positioning System (GPS), such databases allow a vehicle routing system to determine the location of a user's vehicle and to take actions useful to the user, such as computing an optimal route from the current location to a desired destination, providing detailed directions for traversing a route, or providing an estimate of the arrival time at the destination.

However, limitations in the accuracy of GPS devices, combined with cartographic inaccuracies, combine such that uncorrected display of a GPS-determined location (for instance of a vehicle) on an electronic map would place the vehicle at a location that is incorrect, or at least ambiguous, for purposes of vehicle routing. As one common example, limited access highways are often immediately adjacent to service roads, with the right lane of the highway being sometimes only 20 feet away from the leftmost portion of the service road. Should a navigation system in such a situation incorrectly infer which road the vehicle is actually on, it could provide incorrect routing instructions to the vehicle. Likewise, someone driving in a parking lot or surface street underneath a raised roadway may be at almost exactly the same coordinates as the raised roadway itself, leading to similar problems.

There have been some attempts to create systems to more accurately “snap” a vehicle's location to the appropriate roadway on an electronic map. Some such attempts are merely too simplistic to work well, for instance simply picking as the likely location the roadway that is closest based on an instantaneous GPS reading. Other, more sophisticated attempts require significant additional infrastructure. For example, U.S. Pat. No. 6,516,267 teaches updating and enhancing geographic databases to improve the performance of navigation systems, by traversing roadways with data collection vehicles loaded with various sensors usable to augment the databases with highly specific local information.

### SUMMARY

As disclosed herein, a correlation is determined between a vehicle's location and a feature on an electronic map based on correspondence between a reported location of the vehicle and the map feature, responsive to a distance function and at least one additional parameter. In one aspect, the additional parameter is a vehicular operation parameter corresponding to the feature. In other aspects, the operation parameter relates to a speed limit, a direction of travel, historical location information, historical speed information and historical velocity information.

In a further aspect, the parameter relates to information obtained by inference from related roadway characteristic information, such as may be stored in a database. In still a further aspect, the roadway characteristic information is obtained by information from the movement of other vehicles over time.

Some embodiments of the invention augment a map database by deriving entirely new categories of information not previously tracked by the database. In one embodiment, the presence of stop signs is detected by observed or otherwise obtained information about relative sizes of intersecting roadways, vehicle speeds, speed limits, or traffic volumes. Thus, embodiments of the invention can be used to derive additional information about characteristics of the roads themselves, independent of current traffic conditions, and these can be used as factors in determining which of several map features (e.g., a highway or its associated service road) most likely corresponds to an ambiguous GPS location reading for a particular vehicle.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a high-level block diagram of the computing environment in accordance with an embodiment described herein.

FIG. 2 is a block diagram of a user device, in accordance with an embodiment described herein.

FIG. 3A is a diagram of an intersection for which roadway information is inferred as described herein.

FIG. 3B is a diagram illustrating use of historical GPS readings to resolve ambiguity as to which road a vehicle is on.

FIG. 4 is a block diagram of a controller, in accordance with an embodiment described herein.

FIG. 5 is a block diagram illustrating an example of a computer for use as a user device, a traffic signal, or a controller, in accordance with an embodiment described herein.

FIG. 6 is a flow chart illustrating high-level steps performed according to one embodiment.

One skilled in the art will readily recognize from the following discussion that alternative embodiments of the structures and methods illustrated herein may be employed without departing from the principles of the invention described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

### General Method Overview

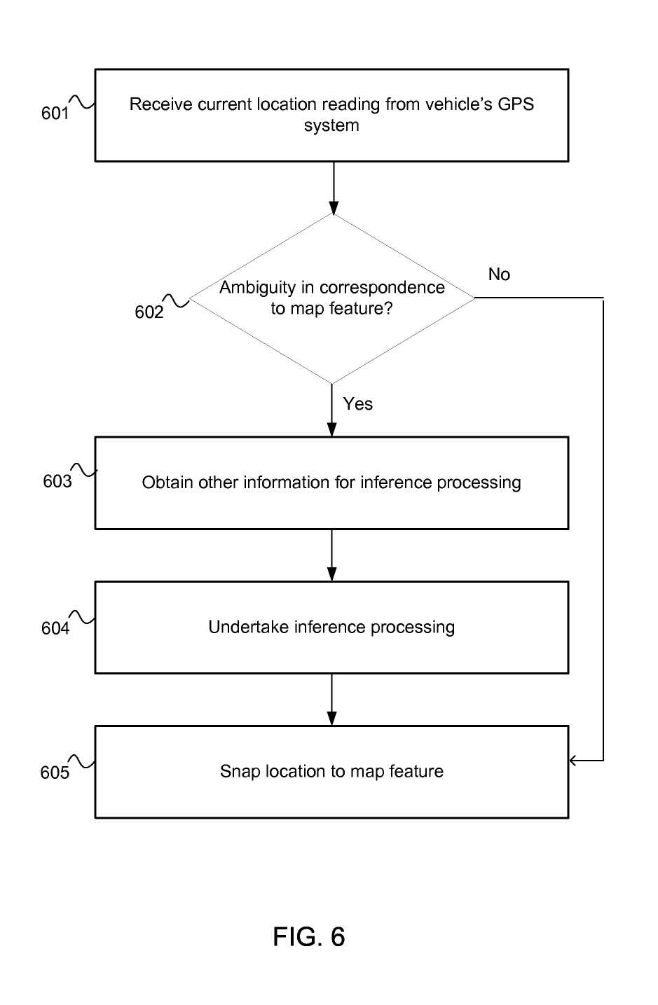

Embodiments of the invention perform various map database augmentation and correction techniques to derive information related to which of several possible map features (e.g., road segments) corresponds to a vehicle's location as reported by a device such as a GPS receiver. Such techniques conform to the general pattern set forth in FIG. 6, described here at a high level and in more detail below. At step 601 of FIG. 6, vehicle location information is obtained from a GPS locator device. In one embodiment, such information is obtained by receipt of vehicle readings provided, for example, by a conventional satellite-based GPS system, and includes location (e.g. latitude and longitude) and velocity (e.g. speed and heading) information for the vehicle to which they correspond. A check 602 is then made relating to correlation between location and map feature information, for instance from a conventional map file or map database. In some instances, this information may be sufficient to unambiguously determine that the vehicle is located on a particular road, for instance if the GPS indicates that the vehicle's location is exactly the same as the location shown on the map for a rural road with no other map features nearby. If so, the location displayed is set to correspond to the map feature in step 605.

In many instances, however, ambiguity remains regarding the exact location of the vehicle. In urban and suburban areas, for example, the accuracy of GPS positioning and the accuracy of electronic maps may not be sufficient to indicate exactly what map feature corresponds to the location of the vehicle. To give just a few examples, some cities have elevated freeways located directly above surface streets, often parallel to one another; some limited access roads have service roads located immediately adjacent to them; other limited access roads have separated lanes for high occupancy vehicles, often with cones or other barriers preventing movement between such lanes and other lanes of the roadway.

Some conventional GPS navigation systems do not rely entirely on GPS data to determine location and vehicle movement parameters. Particularly to deal with situations such as urban canyons and tunnels or other covered roadways, many modern GPS systems augment satellite location data with other sensor data, such as gyroscopic sensors, electronic compasses and orthogonally oriented accelerometers. Regardless of how a GPS-based navigation system determines a vehicle's location, the reported location may be close enough to several map features that reliance on the navigation system's reported location alone may not reliably locate the vehicle on an electronic map, such as a road map on a driver's dashboard display.

In some conventional systems, no attempt is made to establish correspondence between a vehicle's reported location and a map feature, such that the vehicle is shown as being, for example, in the middle of a city block. In other conventional systems, simplistic algorithms snap display of a vehicle's position to the nearest roadway segment. However, as vehicle routing and navigation functions often critically depend on correctly determining where a vehicle is with respect to certain map features, such existing approaches can at times be inadequate.

Thus, at step 603, additional information regarding correspondence between the vehicle and map features is obtained. Such additional information is obtained, in various embodiments, through various mechanisms detailed below. For example, in one embodiment the prior GPS readings for the vehicle may make it far more likely that the vehicle is on one roadway than a second, adjacent and parallel roadway, even if the current GPS reading suggests the vehicle to be closer to the second roadway. In a second example, the velocity of the vehicle may make it far more likely that the vehicle is traveling on a freeway lane rather than a nearby service road lane. In another embodiment, the fact that the vehicle has slowed to a near stop on a multi-lane road adjacent to an at-grade intersection may suggest that the vehicle is in a turning lane rather than an adjacent through-lane. In yet another embodiment, sensor information such as a low GPS signal strength or correspondingly poor GPS accuracy reading may suggest that a vehicle is on the lower roadway of a bridge that has both upper and lower roadways. Modern vehicles have a variety of on-board sensors, many of which are usable to provide such ancillary information—even the day/night sensor of a vehicle, typically used to control vehicle lights, can at times be used to generate an inference as to whether a vehicle is in a middle lane of a road or the right lane of the road (more likely to be shaded by trees or buildings). Likewise, information about other vehicles as well can be used to generate such inferences. For example, historical information regarding speed patterns of other vehicles preparing to take a particularly sharp off-ramp can be used to infer whether a subject vehicle is in a middle lane of a freeway or in an exit-only lane of the freeway.

Presence of map features not already in a map database may be inferred from historical information, and this information can also be used to infer otherwise ambiguous vehicle location information. For example, if one observes that an east-west traffic segment of a road has vehicles traveling at 55 mph (whether determined by a database including the speed limit for that segment or as observed using GPS readings from actual vehicles), and in the same manner that a segment of an intersecting north-south road has vehicles traveling at 30 mph, it may be reasonable to infer the presence of stop signs at the north-south road. As another example, if such an east-west road rarely shows vehicles passing one another but often shows vehicles at some locations coming to a near-stop while other vehicles pass them, it may be reasonable to infer that there is a turning lane on that road.

In many applications, it may not matter that the inference of a turning lane is accurate. There may be wide shoulder that allows through traffic to pass a car waiting to turn. For many applications, however, all that is important is to recognize that there may be a roadway feature not reflected in the map database that is relevant to determining which of two or more possible map features best corresponds with a vehicle's reported GPS fix. To provide yet another example, some “strip shopping centers” along commercial roadways have parking lots that are generally in line with the roadway to which they are adjacent. By comparing a vehicle's speed with the expected speed on the roadway and on the parking lot, a system can infer that an ambiguous vehicle location reading corresponds to one or the other location.

At step 604, the inference processing is undertaken as described in greater detail below, and then at step 605 the map feature that is the best fit for the vehicle's location, based on both the GPS system's reported location and the inferred information as described above is selected for display as the vehicle's location (i.e., the displayed location is “snapped to” the corresponding map feature). In some environments, where GPS system data and map database information are both considered to be robust and quite accurate, the physical distance from the GPS-reported location to the map feature is weighted very strongly and other factors as discussed above have relatively little weight. In other environments, where weak signals are encountered and where dead reckoning from on-board sensors such as accelerometers is relied on by the GPS system, or where the location of features on a map database may be quite inaccurate, the weighting may be quite different. Those skilled in the art will recognize that proper weighting of parameters can be achieved either by manual trial and error or by automated machine learning techniques.

As referenced above, various types of information may be used to infer which of several possible map features most appropriately corresponds to a vehicle's location as reported by a GPS system. It may be desirable to save some such information and effectively augment a map database with the newly inferred information. Continuing with one of the examples given above, a database is updated to reflect the inference that a pair of stop signs are controlling the north-south road of an intersection. Some commercial road map databases have existing fields that can be directly populated with information such as the location and nature of a traffic control device, such as a stop sign or traffic signal, and such information is simply entered in the required manner. Other databases may not have such a provision already available, and for such databases an ancillary structure is created to allow for entry of such inferred information. For instance, a new field may be created in the database that associates a traffic control device with a particular location and direction of travel. In still other embodiments, a database is “augmented,” “updated,” or “modified” by creating an entirely new instance of the database or, in some embodiments, creating an entirely new type of database (e.g., as may be best suited for the nature of information now to be included). Thus, terms such as “updating” as used herein are to be interpreted broadly to include any such manner of including such new information in a database, as may be evident to those skilled in the art.

### System Architecture

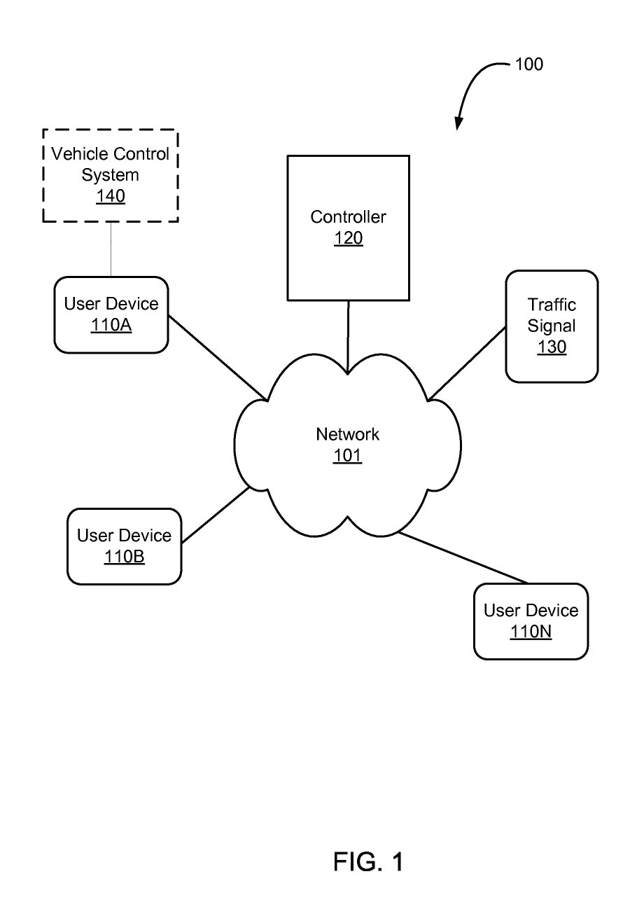

FIG. 1 is an illustration of a system 100 in accordance with one embodiment of the display processing described above. The system 100 includes a plurality of user devices 110A-N coupled to a network 101. In various embodiments, user devices 110 may include a computer terminal, a personal digital assistant (PDA), a wireless telephone, an on-vehicle computer, or various other user devices capable of connecting to the network 101. In various embodiments, the communications network 101 is a local area network (LAN), a wide area network (WAN), a wireless network, an intranet, or the Internet, for example. In one specific embodiment, user device 110 is an iPhone® device provided by Apple Inc. and programmed with a user-downloadable application providing one or more of the functions described herein.

The system 100 may, but need not, include a plurality of traffic signals 130 that are connected to the network 101 and at least one controller 120. In some embodiments, a user device, e.g., 110A, further interfaces with a vehicle control system 140, such as via a Bluetooth or wired connection (e.g., OBD II), to monitor aspects of vehicle operation as described herein.

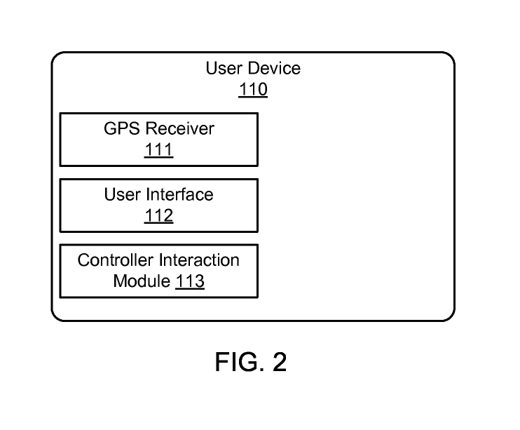

FIG. 2 is a block diagram of a user device 110, in accordance with an embodiment of the invention. In one embodiment, one user device (e.g., 110A) is in the vehicle for which location is currently sought to be displayed, and another user device (e.g., 110B) is in another vehicle that may have traversed the same route at some prior time. In one embodiment, each user device 110 includes a GPS receiver 111, a user interface 112, and a controller interaction module 113. In some embodiments, user interface 112 includes a display with an electronic map on which the vehicle's position is shown; in other embodiments such a display is provided elsewhere (e.g., on a dedicated dashboard display device).

The GPS receiver 111 of the user device 110 functions to identify a location of the user device 110 from GPS satellite system signals received at the user device 110. As noted above, other modes of augmentation may be used besides satellite system signals in GPS receiver 111 as well, for instance on-board compass and accelerometer sensors. Suitable GPS receivers are commonly found in handheld computing devices such as cell phones, on-board navigation systems, and other electronics. The GPS receiver 111 determines the location of the user device 110 for communication to the controller 120. Alternatively or in addition, cellular or Wi-Fi signals, or other known location-determining technologies, may be used to determine the position of the user device 110. The location is discussed herein as having been determined from GPS signals, although GPS signals, cellular signals or other technologies can be used in alternate embodiments.

The user interface 112 of the user device 110 allows the user to input information into the user device 110 and displays information to the user. For example, the user may input a desired destination into the user interface 112 of the user device 110. The user interface 112 may display a map, directions or a route to travel to arrive at the desired destination. The user interface 112 may also display other information relevant to the driver derived from the GPS signals received by the GPS receiver 111, received from the controller 120, or from other sources, such as current speed, upcoming traffic signals, the light status of such traffic signals, and the like.

The controller interaction module 113 of the user device 110 manages the communication between the user device 110 and the controller 120. Specifically, the controller interaction module 113 sends the location information determined by the GPS receiver 111 to the controller 120 and receives the controller's messages to the user device 110 regarding, e.g., the inferred information referenced above. The functions of controller 120 may in actuality be spread among multiple controller devices.

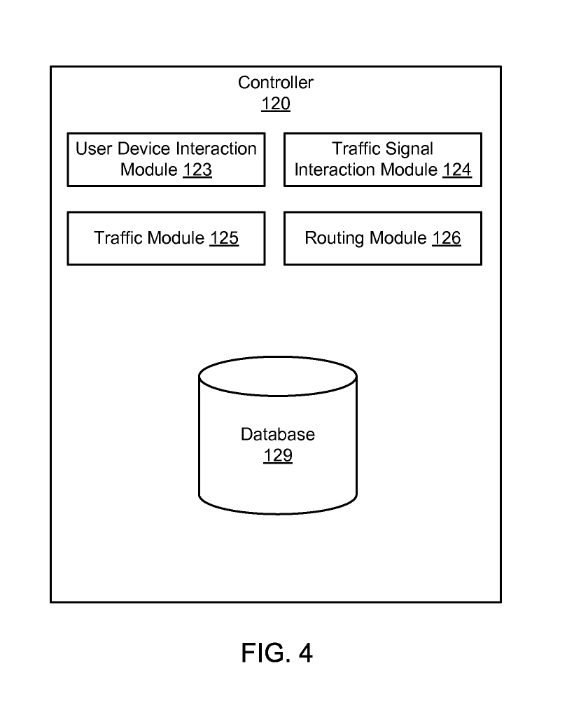

FIG. 4 is a block diagram of a controller 120, in accordance with an embodiment of the routing system. In one embodiment, the controller includes a user device interaction module 123, a traffic signal interaction module 124, a traffic module 125, a routing module 126 and a database 129.

The user device interaction module 123 of the controller 120 manages the communication with the user device 110 from the controller's side. The user device interaction module 123 receives location information and optionally destination information from the controller interaction modules 113 of the user devices 110 and sends map, traffic, routing, or traffic signal related information to the user devices 110 via the user device interaction module 123. Likewise, the traffic signal interaction module 124 of the controller manages the communication with the traffic signal 130 from the controller's side. The traffic signal interaction module 124 may send instructions to the traffic signals 130 and may receive status updates regarding the status of the lights of the traffic signals 130 in various embodiments. In some embodiments, there is no such interaction with traffic signals, and so controller 120 does not include traffic signal interaction module 124.

The traffic module 125 receives information identifying the location and, in some embodiments speed and other GPS data, of the user devices 110 from the user device interaction modules 123 and stores the information in a database 129. The traffic module 125 may also store information regarding traffic conditions from other sources such as other users with user devices 110, traffic services, news reports, and the like. The traffic module 125 may also receive data regarding events likely to influence traffic such as construction projects, emergency vehicle activity, and the like. The traffic module analyzes the received traffic data to determine current and in some embodiments predicted future traffic conditions, and the traffic module 125 may report traffic conditions through the user device interaction module 123 to the user devices 110.

The routing module 126 combines the information communicated to the controller 120 about the locations of the user devices 110 and optionally their destinations with the traffic conditions assessed by the traffic module 125 to prepare routing instructions for the user devices 110. In some embodiments the assessment includes observed traffic conditions, predictive analysis, or both. The routing module 126 may also consider the status and timing of the traffic signals 130 to recommend routes and speeds that result in less time for drivers spent waiting at red lights or that are otherwise advantageous, as well as to provide predicted speeds for all or part of a recommended route. In one embodiment, routing module 126 further processes inferred information as discussed above to determine which of several possible map features corresponds to an ambiguous GPS location reading for a vehicle.

A single database 129 is shown in FIG. 4 as internal to the controller 120, however in other embodiments, the database 129 may comprise a plurality of data stores, some or all of which may reside remotely from the controller 120. For example, the data stores may be elsewhere on the network 101 as long as they are in communication with the controller 120. The database 129 is used to store electronic maps, user device locations, traffic conditions, navigation routes and any other information as detailed herein used by controller 120 for purposes such as analysis or communication with user devices 110 or the traffic signals 130. In some embodiments, such information is stored in other databases, either in locally maintained in user devices 110 or elsewhere. Those skilled in the art will recognize that in certain applications, it may be preferable to store information in one part of system 100, and in other applications, it may be preferable to store similar information in another part of system 100. For purposes of discussion herein, unless otherwise indicated database 129 is referenced generically as the database for storing information used to determine which map feature best corresponds with a vehicle's location.

More generally, the functions described above regarding controller 120 are, in various embodiments, administered by one or more controllers having access as required to database 129, not all of which are necessarily under a common authority. Those skilled in the art will recognize that slightly different implementations may be appropriate for various situations and environments, and will determine which of several possible controllers is responsible for such functions. It also should be noted that implementation of some features described herein requires less than all of the subsystems and modules described above. For example, in some embodiments, there may be no intelligent interaction with traffic signals, so there will be no connection between traffic signal 130 and network 101, and controller 120 will not have a traffic signal interaction module 124.

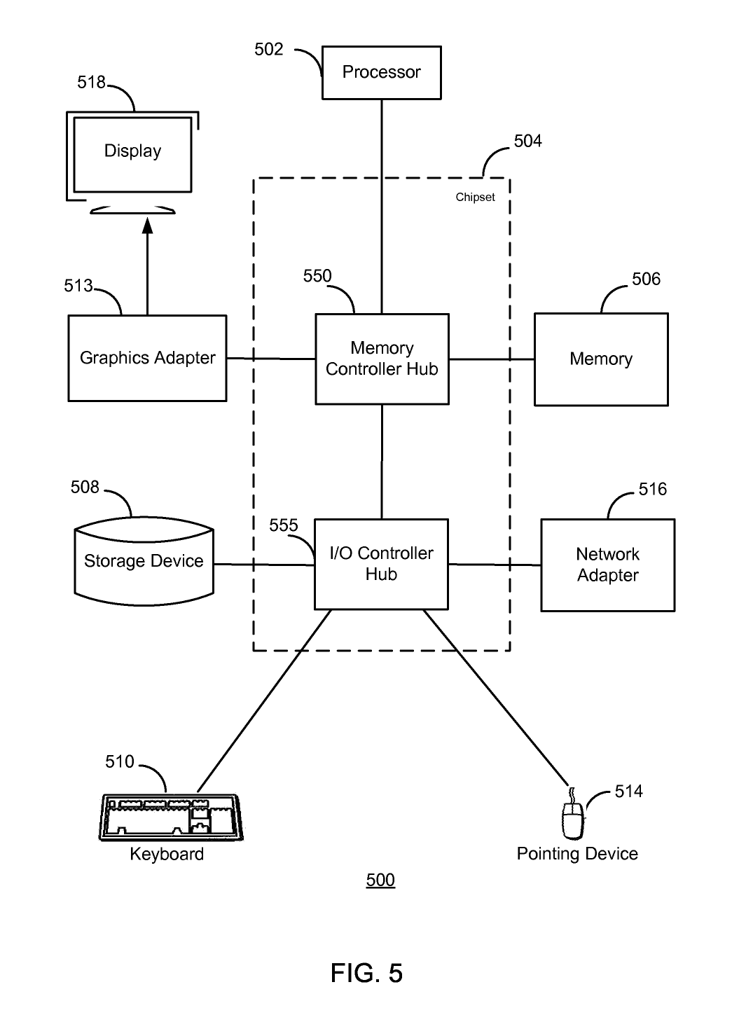

FIG. 5 is a high level block diagram of a computing device 500 usable for processing as described herein. Illustrated are at least one processor 502 coupled to a chipset 504. The chipset 504 includes a memory controller hub 550 and an input/output (I/O) controller hub 555. A memory 506 and a graphics adapter 513 are coupled to the memory controller hub 550, and a display device 518 is coupled to the graphics adapter 513. A storage device 508, keyboard 510, pointing device 514, and network adapter 516 are coupled to the I/O controller hub 555. Other embodiments of the computer 500 have different architectures. For example, the memory 506 is directly coupled to the processor 502 in some embodiments.

The storage device 508 is a computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and in some embodiments is used in combination with the keyboard 510 to input data into the computer system 500. The graphics adapter 513 displays images and other information on the display device 518. In some embodiments, the display device 518 includes a touch screen capability for receiving user input and selections. The network adapter 516 couples the computer system 500 to the network 101. Some embodiments of the computer 500 have different and/or other components than those shown in FIG. 5.

The computer 500 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 508, loaded into the memory 506, and executed by the processor 502.

The types of computers 500 used by the entities of FIG. 1 can vary depending upon the embodiment and the processing power used by the entity. For example, a user device 110 that is a PDA/smartphone typically has limited processing power, a small display 518, and might lack a pointing device 514. The controller 120, in contrast, may comprise multiple blade servers working together to provide the functionality described herein. As noted above, the portion of data storage and processing performed by each device is preferably based in part on the processing power and available communication bandwidth for each such device.

One of skill in the art would recognize that the above described system is merely for purposes of example, and that many other configurations for implementing the invention are equally possible.

### Snap-to-Map Operations

The various map and vehicle location display techniques performed by embodiments as set forth in FIG. 1 are now described in more detail. As previously discussed, one such approach applies the information, such as vehicle speed, provided by a user device to existing information stored in the map database, deriving additional information and selecting a map feature as a current vehicle location accordingly.

In some environments, such as described in co-pending commonly owned U.S. patent application Ser. No. 11/851,953, published Mar. 12, 2009 as US 2009-0070031 (the contents of which is hereby incorporated by reference as if fully set forth herein), the presence or absence of traffic control devices such as stop signs or traffic signals is detected by observing the speed of a vehicle arriving at an intersection, and the nature/duration of delay of the vehicle at an intersection (e.g., a consistent delay of a few seconds suggests a stop sign, while a green/yellow/red traffic light is suggested by vehicles sometimes being delayed by a significant amount and sometimes not being delayed at all). Data from vehicles may be too sparse in some circumstances to determine whether vehicle stops occur frequently enough at an intersection to warrant an inference of a stop sign. However, there may be sufficient data indicating that traffic in the area regularly travels at high speed on an east-west road and a significantly lower speed on an intersecting north-south road. Alternatively, a map database may be available that includes entries indicating a significantly higher posted speed limit on the east-west road than on the intersecting north-south road. Another usable parameter is volume of traffic. The intersection of one roadway having historically high traffic volumes with another, low-volume roadway suggests there may be a traffic control on the low-volume roadway. Still further, there may be information stored in a database as to a classification for a roadway, such as “residential”, “local”, “through road”, “business route” or “federal highway”, and significant classification differences between two intersecting roadways will in some embodiments support an inference of whether a traffic control is present. While such information may not be sufficient to predict with certainty the presence of any particular traffic control device, for an application not requiring absolute accuracy it may be sufficient to recognize a reasonable likelihood that such a traffic control device is present.

In a related application, consider a map database that includes stop sign information but does not currently indicate that there are any stop signs at a particular intersection. If a shopping center is built nearby, that may increase traffic flow sufficiently that the municipality decides to put in a pair of stop signs on one of the two roads forming the intersection. Review of traffic volume data over time as described herein may lead to an inference that a stop sign or traffic light has been added.

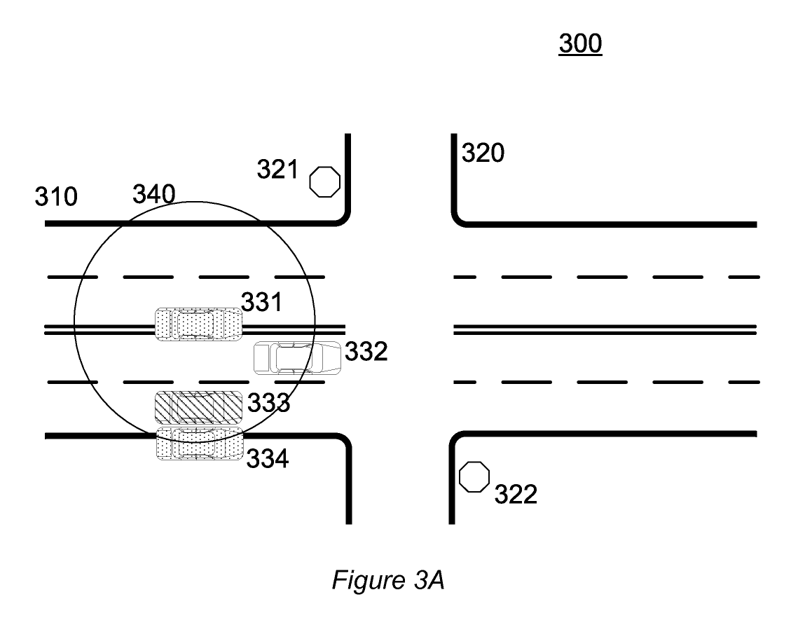

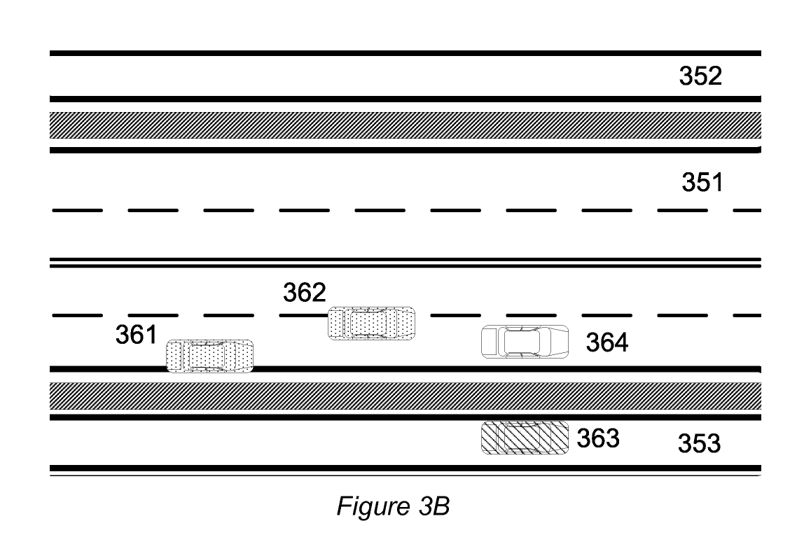

Referring now to FIG. 3A, there is illustrated an intersection 300 between a large east-west roadway 310 and a smaller north-south roadway 320. A commercial map database may represent the larger road 310 differently than the smaller road 320, for instance indicating that the larger road is categorized as a four-lane highway while the smaller road is categorized as only two lanes wide (or possibly less). Assuming that the map database also indicates that the intersection 300 is an at-grade intersection, as opposed to being an intersection involving a bridge or other overpass or tunnel, the difference in size of the roadways alone may be sufficient to infer that the municipality or other controlling roadway authority has installed stop signs 321 and 322 to control traffic on the north-south roadway.

As a slight variation, instead of two intersecting automobile roads, if a roadway intersects a railroad track at grade, that almost certainly indicates a practical need for certain types of vehicles (e.g., school buses, commercial vehicles) to stop before crossing the railroad track. Therefore, for commercial route planning purposes and the like, the addition of a virtual traffic control (the mandatory stop at a railroad track for such vehicles) to a map database allows more accurate navigational services such as travel time planning.

The nature of each roadway is often usable as a factor in how best to infer the type of traffic control. Where a small country road intersects a large U.S. highway at grade level, it is highly likely that there will be stop signs for the small road but not for the U.S. highway. The presence of a divided highway (i.e., a boulevard or other roadway with a median strip separating travel lanes) further increases the likelihood of such a traffic control on an intersecting smaller roadway. Where a smaller road meets a larger road with an arc-shaped segment rather than at a right angle, there is an increased likelihood that a yield sign rather than a stop sign is controlling traffic from the smaller roadway.

Using the example illustrated in FIG. 3A, a pseudo-code representation of processing to infer presence of a stop sign in one embodiment is:

Process Road 310:
a. Augment Counter310 by number of lanes
b. Augment Counter310 if roadway is divided
c. Augment Counter310 by determined speed in mph/10
d. Augment Counter310 if historical traffic volume >20% over average for that type of road

Process Road 320:
a. Augment Counter320 by number of lanes
b. Augment Counter320 if roadway is divided
c. Augment Counter320 by determined speed in mph/10
d. Augment Counter320 if historical traffic volume >20% over average for that type of road

If Counter310−Counter320>3, then infer stop sign on Road 320

If Counter320−Counter310>3, then infer stop sign on Road 310

As noted above, the determined speed for each roadway is obtained either by observation of readings from GPS devices in vehicles over time, or by reference to speed limit data (e.g., from an existing database).

In many instances, each “arm” of an intersection is considered separately, such that road 310 is processed separately for its western arm (“310W”) and eastern arm (“310E”) and road 320 is likewise broken up into arms “320N” and “320S”. This allows more detailed processing that is expected, in various environments, to be more accurate in inferring the presence of traffic controls. In one embodiment, processing in this manner is implemented by considering “local” roads to be those classified as residential or having speed limits of 25 mph or less, while “nonlocalu” roads are those classified as “collectors” or having classifications higher than “residential”. Then, if a map database does not already indicate that an intersection is signalized, processing is implemented in one embodiment as:

Case: Intersection has both local and nonlocal arms
a. If there is only one incoming nonlocal arm, then
   i. If there is a local arm which is a continuation of the non-local arm (same road name or no turn from the non-local arm), then infer stop signs are present on all other local arms
   ii. Otherwise, infer stop signs on all arms.
b. If there is more than one incoming non-local arm, then infer stop signs on all local arms
   i. If there is only one local arm and another non-local arm that is a continuation of the local one, infer stop sign on the non-local continuation arm as well.

Case: T-intersection involving non-local arms only
a. If the two “thru road” arms (i.e., the two arms that are collinear) have a speed limit equal or higher than the “side” arm (i.e, the arm that is orthogonal to the thru road arms), infer stop sign on the side arm.

Case: Four-way intersection involving non-local roads only
a. If one road has a speed limit 10 mph or lower than the other, infer stop signs on the lower speed limit road only; otherwise infer stop signs on all arms.

Various other roadway and traffic control characteristics can be inferred in a similar manner. Consider traffic light characteristics, for example. Many traffic lights are synchronized along a roadway and are coordinated with one another such that vehicles traveling at a specified speed will be able to go through many intersections without encountering a red signal. In some implementations, the specified speed varies based on factors such as traffic congestion levels. There may be no database record indicating that certain lights are synchronized or what the synchronization scheme is. Likewise, certain intersections have phases of operation that vary based on congestion or time of day. A green left turn signal may appear before a general green signal, during the general green or after. Controller timing parameters may be programmed by a municipality based on any number of factors. It is not typical for municipalities to provide this detailed information about phasing or timing patters of traffic lights in a form readily usable by map databases. However, if the actual (i.e., real time) state information from each of the lights is available from the municipality, as is now often the case, the phasing and lighting patterns for each light and each intersection in general can be derived from historical analysis of the concurrent states of various lights, and in some instances comparison with other factors such as time of day, congestion levels and the like.

Those skilled in the art will readily recognize other algorithms that may be employed in other embodiments or environments to obtain reasonable map database inferences, for instance where traffic controls such as stop signs are likely to be located.

Thus, embodiments of the invention allow the capture of numerous additional types of information not previously reflected within the map database, leading to greater functionality and greater accuracy for the increasing number of map applications that rely on such information.

Of particular interest here is an application in determining exactly where on a map display a vehicle is located where the vehicle's reported location from a GPS receiver does not unambiguously locate the vehicle with respect to various map features. Consider FIG. 3A again, but now as a display of an electronic map 300, with a vehicle's GPS receiver indicating the vehicle as marked by the vehicle icon 331. Icon 331 shows the vehicle as being located straddling the middle line of a four lane highway 310, a scenario that is not very likely. In some circumstances, it may well be that a poor driver has positioned the vehicle as icon 331 suggests, but in other circumstances, such as a physically divided highway with cones, poles, cement bumps or barricades protecting the eastbound traffic from the westbound traffic, such positioning would not be physically possible.

While modern GPS receivers generally provide remarkable accuracy, in some situations buildings, trees, overpasses, a vehicle's roof and other features can block a GPS receiver's view of the full constellation of GPS satellites, and a decrease in accuracy in reported location can result. In FIG. 3, circle 340 represents a range of actual possible locations of a vehicle that can be expected to result in a GPS location fix as shown by icon 331. Viewed another way, circle 340 represents an “area of doubt” regarding the specific location of the vehicle—the vehicle is likely somewhere within circle 340, but there is no certainty exactly where within the circle it is.

In some conventional GPS display systems, a simple algorithm to address this uncertainty might be to change the displayed position of the vehicle to match the nearest map feature (e.g., a segment of a map corresponding to a travel lane). However, such a simplistic approach may well yield improper results. For instance, the icon 331 appears to be closer to a westbound lane of roadway 310 than an eastbound lane, so a “nearest feature” algorithm might incorrectly place the vehicle, shown as heading eastbound, into a westbound lane.

Proximity of a reported location to a corresponding map segment is not, then, necessarily the only, or even the strongest, factor determining where the vehicle should be displayed on 300. In the situation illustrated, another important factor is the recent velocity of the vehicle. If the vehicle's GPS system has recently shown it to be moving at highway speed in an eastbound direction, that information may be at least as important as proximity in determining whether the vehicle should be snapped to the eastbound lane rather than the westbound lane.

In a related scenario, consider a situation in which historical data from other vehicles indicates that whenever they at the location shown by icon 332, they invariably turn left (northbound) onto roadway 320. In that instance, a reasonable inference might be that the location corresponding to icon 332 is a left turn only lane. If a vehicle's GPS system shows that the vehicle's speed has recently dropped from highway speed to a very slow speed, a reasonable inference might be that a GPS-reported location indicated by icon 331 coupled with that drop in speed indicates that the vehicle is located as shown by icon 332, and that is where the vehicle should be shown on electronic map 300.

However, if the vehicle's recent speed has remained at or near the highway speed limit, and an inference suggests that the eastbound left lane is in fact a turn-only lane, the same GPS-reported location would instead reasonably lead to a determination that the vehicle is likely in the right eastbound lane, as shown by icon 333.

Were the vehicle's GPS system to report a location indicated by icon 334, the situation would be somewhat different. Assuming the same historical information (i.e., an inference that the left lane is a turn-only lane), a low rate of speed might not suggest as strongly that the vehicle is located as shown by icon 332 (i.e., preparing to turn left). Instead, in this scenario, proximity more strongly suggests the right lane, and a slow rate of speed might well be supported by historical data that vehicles do indeed sometimes travel slowly when at the location indicated by icon 333, as they may be preparing to turn right (southbound) on to roadway 320.

Processing, whether in user device 110 or in controller 120, determines which scenario is more likely by applying a cost function. In one embodiment, the cost function is point-based and assigns a cost to each proposed location (332, 333) based on proximity to a reported location (e.g., 331) and other information. As exemplified above, the other information may be information about the vehicle's reported velocity, historical information about other vehicles that were previously in nearby locations, or static information from database 129 (e.g., information that road 320 is one-way northbound, so a right turn onto road 320 southbound from road 310 eastbound is not permitted for vehicles).

In another embodiment using a slightly different approach, a vector-based cost function is used, in which the cost of changing (vectoring) from a reported location (331) to various map feature locations (e.g., “valid” locations in traveled lanes such as indicated by icons 332, 333) is determined. Those skilled in the art will recognize that various cost functions and other mathematical approaches can be used to determine which of several possible map locations is most likely for any combination of reported GPS location and other factors.

Referring now to FIG. 3B, there is illustrated a scenario in which an electronic map includes a large freeway 351 and two smaller roads 352, 353 adjacent to the freeway 352, but separated from it (e.g., by a barrier) so that traffic cannot move from one roadway to another. In this instance, historical GPS readings can be used to resolve ambiguities in GPS readings and provide more accurate mapping of a vehicle's location. For instance, if three sequential GPS readings indicate the vehicle to first be at the location represented by icon 361, then at the location represented by icon 362, and shortly thereafter at the location represented by icon 363, this information can be used to drive inference processing in the manner disclosed above. Here, however, rather than inferring road features, an inference is made based on prior reported vehicle locations. In this instance, inference processing includes considering a cost of choosing a location on roadway 353, as opposed to on freeway 351, as being driven not solely by a the most current GPS reading (which would strongly favor roadway 353), but on prior readings as well. In this instance, the prior readings strongly favored a location on freeway 351, so the current reading's correspondence with roadway 353 may well be overcome by the weight of those prior readings.

In one specific example of such processing, there is a notional cost c(sᵢ, gᵢ) associated with the vehicle's being on any particular segment sᵢ when GPS reading gᵢ is made, and there is also a transition cost c(sᵢ, sᵢ) associated with moving from segment sᵢ to segment sⱼ. Given a sequence (g₁, . . . , gₙ) of GPS readings, the assumed path of the vehicle is the path (s₁, . . . , sₙ) for which Σc(sᵢ,gᵢ)+Σc(sᵢ,sᵢ₊₁) is minimized. The first term in this expression corresponds to the accumulated cost associated with the “error” at each individual GPS point, which the second term corresponds to the error implicit in moving from each such point to the subsequent one.

Returning once again to FIG. 6, we now provide greater detail regarding the processing steps previously described in a generalized manner. In step 601, vehicle location information is received from an on-board GPS system, for instance GPS receiver 111 of user device 110. In other embodiments, the vehicle location information may be obtained from other subsystems, such as a built-in GPS receiver of the vehicle (communicating with other components of system 100 via vehicle control system 140 or otherwise), or a terrestrial location subsystem of user device 110 (for instance, obtaining location information based on Wi-Fi connections or cellular communication transceivers that are within range). In one embodiment, only actual location information is retrieved from such systems, e.g., the GPS-calculated latitude, longitude and optionally altitude of the vehicle. In other embodiments, ancillary information may also be received in this step. Some GPS receivers, for instance, support transmission of related information via the National Marine Electronics Association (NMEA) standard that includes vector track and speed, and detailed information regarding satellite signals, such as a dilution of precision (DOP) figure indicating the accuracy of a particular location fix based on geometry of the satellites in view and a signal to noise ratio (SNR) figure that likewise bears on the quality of a reported GPS location fix. Some GPS systems internally calculate fix accuracy based on such factors and output an accuracy measurement (e.g., 23 feet for a partially obstructed view of the sky, 9 feet for a clearer view) that can be used directly as described below.

The next step in processing is to compare the reported GPS information with the electronic map used for display of the vehicle's position. In some embodiments, such maps are integrated with the GPS receiver 111 or the user device 110 in which the GPS receiver 111 is implemented, while in other embodiments, map information is stored elsewhere (e.g., in controller 120 or some third party source accessible to the user device via network 101). Wherever it is stored, the electronic map is obtained, and the fix from the GPS receiver is compared to map features. Such processing can take place either within user device 110, or the GPS data can be communicated via network 101 to allow remote processing of such information. Those skilled in the art will recognize that various factors, such as processing power of user device 110 and bandwidth of communications via network 101 will impact how the processing is best distributed among various subsystems.

Electronic maps typically include various map features, each with a stored location. Some electronic map systems are point based, for instance with a roadway being defined as a group of individual points, each of which has a specified location. This is similar to a “bit map” or “raster” approach to defining images on a computer display. Other electronic maps are based on features that are not one dimensional, but instead an origin location and a primitive shape (line, curve, polygon) with a size and orientation, for example a line heading in a direction of 122 degrees from True North for a distance of 36 feet. Such systems are similar to a “vector graphics” approach to defining images on a computer display. Whatever type of electronic map is used, what appears to be a roadway on the map display may be thought of as a set of map features (e.g., a specific pixel for a bitmap representation or a vector with a specific direction and distance from an origin for a vector-based representation).

Each such map feature corresponds to a given location. Depending on the number of features the map contains, and the density and distribution of those features, a particular GPS location fix for a vehicle may unambiguously correspond to a single map feature, or may potentially correspond to several map features. A determination is made in step 602 as to whether there is such ambiguity in the correspondence between the reported GPS location of the vehicle and a map feature.

As a starting point, map features are typically categorized to facilitate display, navigation, and other map-related features and functions. A railroad track and a building are typically recognized as being of a different nature than a road, both so that they are depicted differently on a display and so that they are not (typically) considered valid locations for a vehicle. Conventional “snap to map” processing is based on this distinction, and forces a vehicle's displayed location to match a map feature appropriate for a vehicle (e.g., a road or parking lot). In addition, however, step 602 checks to see whether several map features that are valid for vehicles may correspond to the fix reported by GPS receiver 111. For instance, referring once again to FIG. 3, a check is made to see how many map features are within circle 340, which indicates the range of possible actual locations that may correspond to a GPS-reported fix as shown by icon 331. Note that GPS inaccuracy may be responsible for only part of such ambiguity, and additional ambiguity may arise from cartographic inaccuracy of roadway features. Thus, even for an assumed perfect GPS reading, a “map quality” ambiguity may still result in an “area of doubt” as indicated by circle 340. In some embodiments, both GPS and cartographic figures of merit are used to determine such an area of doubt.

In any event, once such an area of doubt (e.g., circle 340) is determined, step 602 checks to see how many map features are located within that area. For the example shown in FIG. 3, there may be several such features. In addition to locations indicated by icons 332 and 333, there is likely a map feature in the left eastbound lane (i.e., between icons 331 and 333) and a corresponding map feature in the left westbound lane, which in this example is likely the closest feature to the reported position. Thus, processing continues to step 603. Had the map included fewer features, for instance no indication of individual lanes in either direction, there might have been only one map feature within the area of doubt (indicated by circle 340), in which case processing would proceed directly from step 602 to step 605.

For completeness, it should be noted that a third possibility exists, i.e., no map features are within the area of doubt. In some embodiments, the area of doubt is statistically based, so that it merely represents a probability threshold regarding the likelihood of accuracy. Further, there is a possibility that the vehicle has, in fact, traveled to a location for which there is no corresponding map feature (e.g., to a location in a farm field for which there is no map data). In some embodiments, when this situation occurs no attempt is made to snap the vehicle's location to a map feature. In practice, such selective processing is quite helpful, as some conventional map systems that always snap a vehicle's location to map features provide misleading displays through that approach. Such systems, for example, show a vehicle as remaining at a first ferry landing for half of a ferry journey, and then suddenly snap the displayed location of the vehicle to a destination ferry landing, providing no indication to the vehicle's occupants of the actual incremental progress of the ferry journey.

It should also be noted that in some environments, the check for ambiguity in step 602 need not be made, and inference processing will take place in all instances. This might be the case, for example, when the inference analysis does not consume any significant processing power compared to the available resources from the computing device being used for the processing, such that there is no significant concern about overhead caused by such processing. In this instance, the notion of a circle defining an area of doubt is not needed.

In situations in which step 602 determines that there is ambiguity, other information that can be used to resolve the ambiguity is obtained in step 603. As mentioned previously, this other information can come from a variety of sources in various embodiments, including prior location readings for the vehicle, on-board sensors, stored data in controller 120 from the travels of other vehicles, historical data from user device 110 regarding prior travels of the vehicle being tracked over a similar route, and inferred features not already present in the electronic map and its corresponding database (e.g., database 129). Examples of specific information used in various embodiments are discussed in the following paragraphs.

One basic attribute of a map feature corresponding to a roadway is vehicle direction. This information may or may not exist natively in a map database. In some instances, there may be additional GPS data available, other than the current GPS fix, that provides such information. Even if not, this information is capable of being derived from the historical movement of other vehicles, as stored in database 129. In some circumstances, it may be useful to derive such information not only from historical data corresponding to the map segment of interest, but from surrounding map segments as well. For example, if an overpass temporarily reduces GPS accuracy, knowing the map feature (e.g., eastbound lane of highway 310) the vehicle was in previously can be used as a factor in determining the most appropriate map feature corresponding to the vehicle's current location (e.g., strongly favoring an eastbound lane over a westbound lane). Even information regarding GPS accuracy may be useful and therefore can be collected for inference processing. For instance, in Northern Virginia, presence of an elevated train structure such as the Metro in the center median of a roadway such as the Dulles Access Highway may result in a significantly larger area of doubt (circle 340) for vehicles in the left lane westbound on the roadway than vehicles that are eastbound or for vehicles that are westbound in the right lane, since in Northern Virginia most of the GPS satellites are located in the southern sky. Thus, merely knowing that a vehicle's GPS accuracy is significantly lower than usual can be used to bias an inference toward a westbound direction, and even towards a left-lane map feature.

In addition to direction of travel, vehicle speed information may be useful to resolve ambiguities. If a map database already includes speed limit or historical speed information, this information can be collected directly for each candidate map feature to help resolve ambiguity. If the information is not already stored, it can still be obtained by deriving it from historical information regarding other vehicles, as stored in one embodiment in database 129. Consider a limited access road with relatively sharply curved off-ramps, such as the George Washington Memorial Parkway in Northern Virginia or the Northern State Parkway on Long Island, N.Y.. At least during uncongested periods, a vehicle decelerating in advance of such a turnoff is more likely to be in the right lane, preparing to enter the sharply curved off-ramp, than in the left lane, continuing its travel on the parkway. If such a deceleration pattern is observed from historical data of other vehicles, similar deceleration in a tracked vehicle is usable to bias in favor of a right lane map feature rather than a left lane map feature. As mentioned above, many highways have limited access lanes geographically adjacent to service lanes, with the service lanes having at-grade intersections, traffic lights, stop signs and other features allowing observation of speed data to generate a bias relating to whether a vehicle is on a limited access lane or a service road lane. Those skilled in the art will recognize numerous other speed-related scenarios similarly usable as biasing factors.

Another source of information that may be used for inferences is on-board information, such as may be available via vehicle control system 140. As one example, if a vehicle's left turn signal is on, that information can in appropriate circumstances be used to bias toward the vehicle being in the left lane rather than the right lane of a multi-lane highway, preparing to make a left turn. If the vehicle is has energy efficiency features such as automatic turn-off of its engine when the vehicle is stopped, this information can be used to infer that slight changes in reported location of the vehicle are likely the result of GPS inaccuracies (position jitter) rather than actual movement of the vehicle, thus suggesting that the vehicle is at a red light, rather than stuck in traffic.

For each map feature within an area of doubt, there may already exist in database 129 or elsewhere such information usable for inference processing. In some embodiments, if there is no such information already in existence, it is generated on an as-needed basis in step 603, and optionally stored in database 129 for future use.

In step 604, such information is used to generate inferences regarding which of several candidate map features best corresponds to the vehicle's actual location. As mentioned above, in one embodiment a cost function is used to consider all of such factors and generate inference measures therefrom. Consider the situation illustrated in FIG. 3A, with a GPS fix indicated by icon 331 and two candidate map features corresponding to icons 332 and 333. Assume for this example that inference processing has, at some prior time, already determined that icon 332 represents a location from which vehicles only turn left (i.e., a left turn only lane). Further assume that in this instance, GPS speed data was obtained directly in step 601 along with the vehicle's GPS location reading, or alternately vehicle speed was obtained in step 603 by comparing the most recent GPS fix with a prior GPS fix for the vehicle. Still further assume that such speed was determined to be 2 miles per hour. Inference processing in such instance may be represented in pseudocode as follows:

Determine distance cost between 331 and 332

Determine distance cost between 331 and 333

Determine speed cost between 2 mph and typical observed speeds at 332

Determine speed cost between 2 mph and typical observed speeds at 333

Generate overall cost measure for 332

Generate overall cost measure for 333

Select map feature with lowest cost

In this instance, the distances 331-332 and 331-333 are nearly the same, so distance is not a particularly helpful factor. However, the 2 mph speed of the vehicle may be highly relevant. In this instance, it may be extremely rare for a vehicle traveling in the right lane at feature 333 to be going so slowly, but it may be quite common for a vehicle in the left lane, which is a turn-only lane, to be going so slowly, particularly if it is waiting for westbound traffic to clear. Thus, the speed cost measure for feature 333 will be much higher than for 332, and as a result the map feature with the lowest cost will be 333.

As a second example, consider the situation illustrated in FIG. 3B, with a GPS fix indicated by icon 363 and two candidate roadways 351 and 353. Assume for this example that inference processing has, at some prior time, already determined that there is no manner for a vehicle located in this general region to readily have a segment change from roadway 351 to 353. Further assume that in this instance, prior GPS location readings corresponding to icons 361 and 362 were obtained for the vehicle. Inference processing in such instance may be represented in pseudocode as follows:

Determine nearby map features based on current GPS fix

Determine segment transition cost corresponding to sequence 361, 362, 363 and the cost associated with identifying segment 363 as the vehicle's current location

Determine segment transition cost corresponding to sequence 361, 362, 364 and the cost associated with identifying segment 364 as the vehicle's current location

Select map feature with lowest total cost

In this instance, the nearby map features (i.e., valid possible locations given the GPS fix and map features that are possible candidates for location of the vehicle) are shown as icons 363 and 364, with 363 corresponding to the current GPS reading and 364 being the only other map feature suitable for a vehicle within the zone of doubt of the GPS reading. Here, since there is a barrier between roadway 351 and roadway 353, determining the cost of the sequence 361, 362, 363 will result in a very high segment transition cost figure, since such movement would not be expected and would require a transition from a first segment (corresponding to roadway 351) to a second segment (corresponding to roadway 353). On the other hand, the segment transition cost of the sequence 361, 362, 364 will be extremely low, since those three locations are along the same travel lane of roadway 351. As a result, selecting the map feature with the lowest cost will in this instance result in selection of the location corresponding to icon 364, even though the GPS fix showed location 363 as the actual location.

In a slightly different scenario, a segment transition cost might also be imposed for a change of lane on roadway 351, but that transition cost would be far lower than the cost in “jumping” the barrier from roadway 351 to roadway 353. In various embodiments, combinations of such specific cost functions described in the above paragraphs are used, each with appropriate weightings, to allow various factors to influence an overall cost function.

Finally, at step 605, the displayed location of the vehicle, typically indicated by a pointer, crosshair, or icon, is shown as being at the selected map feature, an operation referred to herein as “snapping” the vehicle's location to the selected map feature.

Embodiments that provide systems, methods, and computer-readable storage media that use location-based technologies such as GPS to provide improved correspondence between GPS-derived locations and map features have been described above. Benefits of these embodiments include improved navigational capabilities since navigation systems will be better aware of the specific location of a vehicle, improved opportunity for synchronizing vehicles with one another and supporting use of roadways by autonomously operated vehicles, and improved tracking of vehicle movement to allow inferential augmentation of map information.

Such embodiments further provide users with incentives to keep their user devices 110 in active operation while enroute, rather than just at the outset of a journey. This is advantageous to all users of the system because the more users who are “live” on the system (e.g., have the appropriate application operating on their user devices 110), the more information can be collected from such users and used for the inferential processing described herein. Using the example of an iPhone, for instance, if an “app” implementing the system is kept on during transit, not only will the user obtain updated information, but the system will obtain ongoing information from that user.

In some embodiments, data collected from user devices 110 over a period of time is stored in database 129 and processed further by controller 120 to determine or refine routes proposed by routing module 126. As previously discussed, vehicle speed information collected over a period of time can be used to determine map features such as the presence of stop signs that were not previously known by the system. Similarly, over a long period of time it may be evident that no user devices 110 have traversed a given portion of a mapped road. Such data may indicate that the road was planned but never built, that the road has been closed, or that the road is unavailable for use for some other reason. Based on such collected data, inferences can be made as described herein. Conversely, location and speed data from user devices 110 may indicate that a new road has been built that is not on the base map loaded into database 129, and if there is enough vehicular use of such a route, then routing module 126 assumes such a path, even though not mapped, is available for a proposed route and if should be considered a valid display location for a vehicle.

Still more detailed collected and real-time information from user devices 110 is used by system 120 in certain embodiments. Real-time average vehicle speed from other vehicles, historical average vehicle speed, vehicle speed variance over time, deviation of a given user's vehicle speed compared to other vehicles' speeds over the same route (indicating an aggressive or conservative driving manner) and best/worst case speed data are all usable as inputs to make inferences of the type discussed herein.

In certain embodiments, system 100 adaptively segments routes into smaller pieces over time when collected data suggest such smaller segmentation will yield better inferences. For example, system 100 may start out by considering the entirety of a street as one segment, but data collected over time may indicate that there is a certain portion of the road in which GPS readings often have particular significance. In response, system 100 divides the road into a number segments, so that each can be considered separately.

In some instances, external data sources are used instead of, or in addition to, the collected data referenced above. For example, in one embodiment significant periodic changes in observed traffic at a particular location trigger system 100 to search external data sources (such as through a location-based internet search) to determine a cause of such changes, such as presence of a school, church, railroad crossing or sports venue; notice of a period of road construction; or public warning that a road is only seasonal and is not maintained in winter. In such embodiments, system 100 is programmed to then search for information that correlates with the observed data and can be used to make inferences as described herein. In an exemplary embodiment, should system 100 determine, by a location-based search, that a school is located where there are large variations in transit time, system 100 then searches the Internet for a school calendar and extracts information as to what days the school is open so that the system can use not only raw speed information, but speed information correlated with time of day, to infer whether a vehicle is likely in a lane used to turn into a school parking lot.

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that various of the process steps and instructions disclosed herein could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A system for correlating a vehicle's location with a displayed map feature, comprising:
a data reception module configured to obtain a location fix for the vehicle;
a database subsystem operably connected to the data reception module configured to provide a subset of map features responsive to the location fix; and
an inference processor operably connected to the database subsystem and configured to obtain inference data pertinent to which of the subset of map features should be selected as the displayed map feature, and processing the subset of map features responsive to the location fix and the inference data to determine a correspondence between the vehicle's location and the displayed map feature.

2. The system of claim 1, wherein the inference data relate to characteristics of the map features and are derived from observed vehicle movement.

3. The system of claim 1, wherein the inference processor is operably connected to the data reception module and is further configured to obtain therefrom, as the inference data, at least one of: a prior vehicle location reading, a vehicle speed reading, a vehicle direction reading, a location accuracy reading, a signal quality reading, a satellite geometry reading.

4. The system of claim 1, wherein the inference processor applies a cost function using a first parameter type related to distances between the location fix and each of the subset of map features and one or more additional parameter types related to the inference data.

5. The system of claim 1, wherein the inference processor applies a cost function using a first parameter type related to distances between the location fix and each of the subset of map features and a second parameter type related to vehicle speed.

6. The system of claim 1, wherein the inference processor applies a cost function using a first parameter type related to distances between the location fix and each of the subset of map features and a second parameter type related to vehicle direction of travel.

7. The system of claim 1, wherein the inference processor applies a cost function using a first parameter type related to distances between the location fix and each of the subset of map features and a second parameter type related to speed limits corresponding to each of the subset of map features.

8. The system of claim 1, wherein the inference processor applies a cost function using a first parameter type related to distances between the location fix and each of the subset of map features and a second parameter type related to cost of transitioning from a first segment to a second segment.

9. A method of correlating a vehicle's location with a displayed map feature, comprising:
obtaining a location fix for the vehicle;
obtaining a set of map features responsive to the location fix;
obtaining inference data pertinent to which of the subset of map features should be selected as the displayed map feature; and
selecting one of the subset of map features to be the displayed map feature based on the location fix and the inference data.

10. The method of claim 9, wherein the inference data relate to characteristics of the map features and are derived from observed vehicle movement.

11. The method of claim 9, wherein the inference data relate to at least one of: a prior vehicle location reading, a vehicle speed reading, a vehicle direction reading, a location accuracy reading, a signal quality reading, a satellite geometry reading.

12. The method of claim 9, wherein said selecting includes applying a cost function using a first parameter type related to distances between the location fix and each of the subset of map features and one or more additional parameter types related to the inference data.

13. The method of claim 9, wherein said selecting includes applying a cost function using a first parameter type related to distances between the location fix and each of the subset of map features and a second parameter type related to vehicle speed.

14. The method of claim 9, wherein said selecting includes applying a cost function using a first parameter type related to distances between the location fix and each of the subset of map features and a second parameter type related to vehicle direction of travel.

15. The method of claim 9, wherein said selecting includes applying a cost function using a first parameter type related to distances between the location fix and each of the subset of map features and a second parameter type related to speed limits corresponding to each of the subset of map features.

16. The method of claim 9, wherein said selecting includes applying a cost function using a first parameter type related to distances between the location fix and each of the subset of map features and a second parameter type related to cost of transitioning from a first segment to a second segment.

17. A non-transitory computer-readable storage medium storing executable computer program code for correlating a vehicle's location with a displayed map feature, the computer program code comprising instructions for:
obtaining a location fix for the vehicle;
obtaining a set of map features responsive to the location fix;
obtaining inference data pertinent to which of the subset of map features should be selected as the displayed map feature; and
selecting one of the subset of map features to be the displayed map feature based on the location fix and the inference data.

18. The non-transitory computer-readable storage medium of claim 17, wherein the inference data relate to characteristics of the map features and are derived from observed vehicle movement.

19. The non-transitory computer-readable storage medium of claim 17, wherein the inference data relate to at least one of: a prior vehicle location reading, a vehicle speed reading, a vehicle direction reading, a location accuracy reading, a signal quality reading, a satellite geometry reading.

20. The non-transitory computer-readable storage medium of claim 17, wherein said selecting includes applying a cost function using a first parameter type related to distances between the location fix and each of the subset of map features and one or more additional parameter types related to the inference data.

21. The non-transitory computer-readable storage medium of claim 17, wherein said selecting includes applying a cost function using a first parameter type related to distances between the location fix and each of the subset of map features and a second parameter type related to vehicle speed.

22. The non-transitory computer-readable storage medium of claim 17, wherein said selecting includes applying a cost function using a first parameter type related to distances between the location fix and each of the subset of map features and a second parameter type related to vehicle direction of travel.

23. The non-transitory computer-readable storage medium of claim 17, wherein said selecting includes applying a cost function using a first parameter type related to distances between the location fix and each of the subset of map features and a second parameter type related to speed limits corresponding to each of the subset of map features.

24. The non-transitory computer-readable storage medium of claim 17, wherein said selecting includes applying a cost function using a first parameter type related to distances between the location fix and each of the subset of map features and a second parameter type related to cost of transitioning from a first segment to a second segment.
